(19) United States
(12) Patent Application Publication
(10) Pub. No.: US 2004/0086261 A1
(43) Pub. Date: May 6, 2004

(54) Video segment extraction system and method

(76) Inventor: David H. Hanes, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/285,773

(22) Filed: Nov. 1, 2002

(51) Int. Cl. H04N 5/76; G11B 27/00; H04N 5/781

(52) U.S. Cl. 386/52; 386/94; 386/125

(57) ABSTRACT

Video segment extraction methods and systems are disclosed. One method comprises selecting a segment from video data encoded on an optical video storage medium, and copying the segment from the optical video storage medium to another storage medium to be processed. A video segment extraction system comprises a video data processing module and video extraction logic operatively associated with the video data processing module. The logic is operable to cause a segment from video data encoded on an optical video storage medium to be selected and cause the segment from the optical video storage medium to be copied to another storage medium to be processed.

### TECHNICAL FIELD OF THE INVENTION

The present invention relates in general to video processing systems and more specifically to a video segment extraction system and method.

### BACKGROUND OF THE INVENTION

Optical video storage media such as Digital Versatile Discs (DVDs) enable consumers to create their own personal discs. Consumers may use video devices such as analog and digital camcorders and digital cameras to capture moving pictures and still-framed pictures to record home movies or videos. In addition, recently, consumers have been able to record data that may be captured or streamed over the Internet.

The convenience of optical video storage media such as DVDs enable consumers to easily and inexpensively capture large quantities of video material for archival and review. For example, consumers may wish to archive old home movies that were captured using analog and digital formats. Usually, a consumer may create and record a DVD by using off-the-shelf software such as MYDVD authoring software available from SONIC Solutions. Then, the user may review the data using available DVD technology. In many cases, the consumer may wish to create a new DVD using content from at least one DVD that the consumer has previously created. However, current systems and methods require the user to import all of the DVD content from each of the discs to a storage medium such as a computer's hard drive. Only after importation of the data may the consumer then extract the portion or portions of video that he or she is interested in. Such a process, in many cases, requires a large amount of storage capacity to accommodate this data, which may amount to as much as several gigabytes per disc. Furthermore, such a process requires large amounts of processing time to accommodate reading and writing this data. This process increases in complexity with the number of discs from which the consumer wishes to extract data.

### SUMMARY OF THE INVENTION

From the foregoing, it may be appreciated that a need has arisen to enable extracting video from storage media as desired. In accordance with the present invention, a video extraction method and system are provided that substantially eliminate or reduce disadvantages and problems of conventional systems.

One embodiment of the present invention is a video segment extraction method. The method comprises selecting a segment from video data encoded on an optical video storage medium, and copying the segment from the optical video storage medium to another storage medium to be processed.

Another embodiment of the present invention is a video segment extraction system. The system comprises a video data processing module and video extraction logic operatively associated with the processing module. The logic is operable to cause a segment from video data encoded on an optical video storage medium to be selected and cause the segment from the optical video storage medium to be copied to another storage medium to be processed.

Yet another embodiment of the present invention is a video segment extraction application. The application comprises a storage medium and video extraction application software communicatively associated with the storage medium. The application software is operable to cause a segment from video data encoded on an optical video storage medium to be selected and cause the segment from the optical video storage medium to be copied to another storage medium to be processed.

Still another embodiment of the present invention is a video segment extraction method. The method comprises selecting a segment from video data encoded on a digital video disc (DVD), and copying the segment from the DVD to another storage medium.

Another embodiment of the present invention is a video segment extraction system. The system comprises a video data processing module and video extraction logic operatively associated with the processing module. The logic is operable to cause a segment from video data encoded on a DVD to be selected and cause the segment from the DVD to be copied to another storage medium to be processed.

And yet another embodiment of the present invention is a video segment extraction application. The application comprises a storage medium and video extraction application software communicatively associated with the storage medium. The application software is operable to cause a segment from video data encoded on a DVD to be selected and cause the segment from the DVD to be copied to another storage medium for further processing.

### BRIEF DESCRIPTION OF THE DRAWINGS

For a more complete understanding of the present invention and the advantages thereof, reference is now made to the following description taken in conjunction with the accompanying drawings, wherein like reference numerals represent like parts, and in which:

FIG. 1 is a block diagram of an embodiment of a system that may be used for video extraction according to the present invention;

FIG. 2 illustrates an example of a method for video extraction according to the present invention; and

FIG. 3 graphically illustrates a representation of an example of a video segment that may be extracted from an optical video storage medium according to the present invention.

### DETAILED DESCRIPTION OF THE DRAWINGS

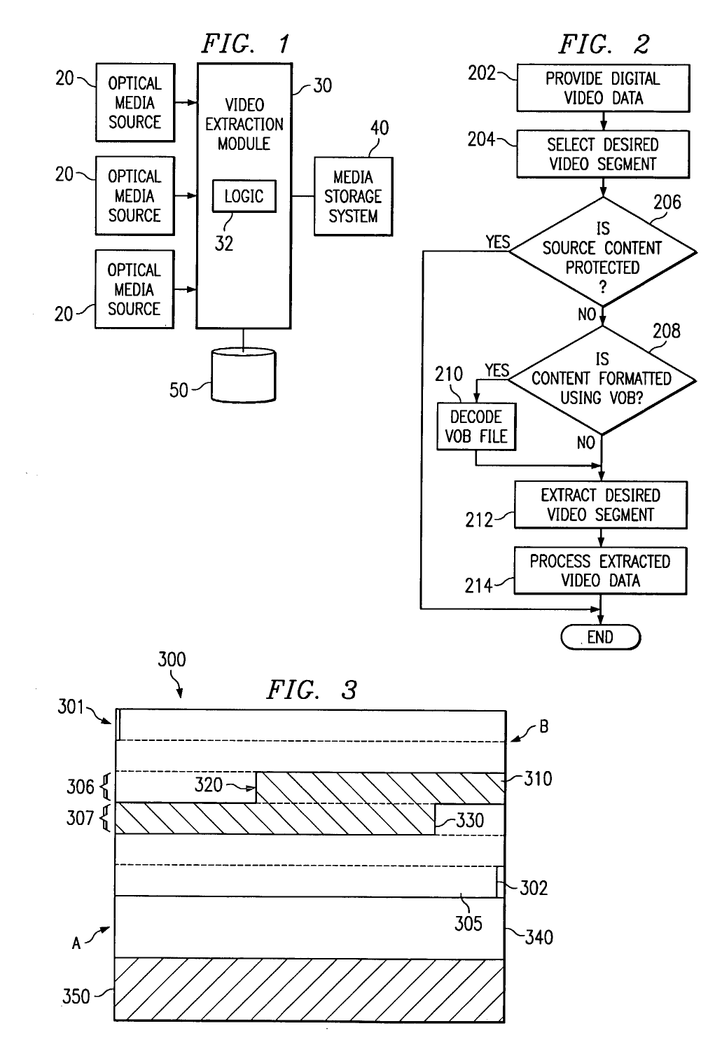

FIG. 1 is a block diagram of an embodiment of a system that may be used for video extraction according to the present invention. In the embodiment illustrated in FIG. 1, system 10 comprises a video extraction module 30, at least one video source 20 and, optionally, a storage medium 50 and/or a media storage system 40. One advantage of the present invention is to provide for video extraction from optical video storage media provided by at least one optical video storage media source 20. As one example, embodiments of the present invention are particularly useful in the storage of home videos or other program material that may be contained on multiple optical video storage media. Because such embodiments provide for video extraction from an optical video storage medium, such as a DVD disc, without the need for a user to copy the entire contents of the optical video storage medium, a user is now able to conveniently retain only the formatted video data that he desires. Accordingly, the present invention may obviate the need for a user to maintain large available computing storage capacity and/or bus bandwidth that would otherwise be required to extract such desired video data. Moreover, the present invention contemplates methods and systems for video extraction that reduce the possibility that unauthorized users could alter and/or violate copyright protection of certain data on the system, thereby improving the ability to effectively manage digital rights of data. Some examples of digital rights include the rights to publish, to transfer, and/or to copy data under copyright laws of various jurisdictions, including the United States.

Video extraction module 30 operates in conjunction with logic 32 to extract desired video data received from video data sources 20 and to store the extracted video data on other media, such as optical video storage media. In the embodiment illustrated in FIG. 1, extracted video data may be stored on optical video storage media such as DVD discs using media storage system 40. In the embodiment shown in FIG. 1, video extraction module 30 may access and/or include programs or software routines of logic 32, depending on the particular application. For example, these routines may include, but not limited to, compression, encoding, and/or frame-indexing routines. Alternatively, or in addition, video extraction module 30 may include, or be coupled to, logic 32 that may be implemented in a variety of hardware and/or firmware configurations, including but not limited to, compression and/or encoding cards.

Video extraction module 30 may optionally be coupled to, or include, a memory system, such as a cache or random access memory (RAM) and/or storage medium 50, suitable for storing all or a portion of these programs or routines and/or temporarily storing video or other data during and/or after various processes performed by video extraction module 30. Such memory may be used, among other things, to support real-time analysis and/or processing of video data streams. Real-time processing may be defined as a speed at which video data is being recorded to an optical video storage medium such as a DVD. For example, when using an analog camcorder, real-time may be defined as a speed at which a movie is normally played back.

Video extraction module 30 may also in a particular embodiment control the overall function and operation of system 10. For example, video extraction module 30 may be a general-purpose programmable computer, such as a personal computer (PC) or other processing platform, such as a server, which are well known and readily available. Alternatively, video extraction module 30 may be more a task-specific or custom-designed processing system such as, but not limited to, a video editing workstation, that may be specifically configured to interface with various devices and to perform in accordance with the methods described herein.

Media storage system 40 is operable to store data on an optical video storage medium, such as a compact disc (CD), a Video Compact Disc (VCD), or Digital Versatile Disc (DVD), and is communicatively coupled with, and stores extracted data received from, video extraction module 30. Although once optical video storage media has data stored therein, it may be referred to as a media storage system, this description uses the term “media storage system” a system operable to store data on an optical video storage medium such as a DVD disc. Similarly, this description uses the term “optical video storage media” optical video storage media, whether the media has data stored therein. The extracted data stored on the optical video storage medium may then be viewed, as desired, using any suitable playback device, e.g., a DVD movie player or DVD-ROM drive. Any DVD media storage system may then be used to store data on a compatible optical video storage medium such as a DVD disc, which may then be played back on any of a wide range of DVD playback systems that are also well-known and readily commercially available. Alternatively, other types of media storage systems 40 that are now known or that may be developed in the future may be substituted for media storage system 40 to store extracted data on optical video storage media during or after extraction from video data streams received from at least one optical video storage media source 20.

Optical video storage media sources 20 each provide a video data stream to video extraction module 30. Optical video storage media sources 20 may each be a media storage system operable to store data on optical video storage media such as, but not limited to, VCDs and/or DVDs, and include any of a wide range of systems and devices now known in the art or that may be developed in the future. For ease of illustration, and not for limiting purposes, this description uses the term “DVD” conjunction with the discussion in FIGS. 1-3. Thus, while the embodiments illustrated in FIGS. 1-3 and described herein are used to extract from and/or store formatted data on optical video storage media such as DVD discs, other optical video storage media currently known in the art or that may be developed in the future may also be used.

In addition, although video data is described herein as digital data that may be received and/or stored in certain formats such as, but not limited to, Universal Disc Format (UDF), or Video Object format (VOB), as defined in the “DVD Specifications for Read-Only Disc, Part 3 Video Specifications, Version 1.0, August 1996,” other formats or data structures may also be used. Thus, the method and system of the present invention should not be limited to the particular storage media, storage formats, and/or data storage structures that are shown and described herein.

Logic 32 may include functionality of, or be compatible with, video disc creation and/or video authoring engines, which may be software, firmware or hardware, or a combination thereof. Two such software packages currently commercially available are DVD WRITER, a video disc creation package, and MYDVD, a video authoring package, both available from Hewlett Packard Company. For example, a user may transfer three videotapes to DVD using authoring software such as MYDVD, in conjunction with DVD WRITER. In other words, logic 32 may be modified to include such authoring and/or creation functionality, as well as functionality enabling a user to extract at least one desired video segment, according to teachings of the present invention.

Then, as another example, the user may select one or more segments from a video data encoded on an optical video storage medium. In this description, the term “segment” used to denote any subset of the data stream encoded on an optical video storage medium. Thus, a segment may be a scene, a clip, a frame, or substantially all of the data encoded on the optical video storage medium, or any portion therebetween. If the user desires, the user may select all of the data encoded on the optical video storage medium by selecting a plurality of segments, and the user may also select multiple segments from one or more media. Using logic 32, the user may mark a start point and an end point using a scrub bar or slider using a software graphical user interface (GUI). Logic 32 is then operable to extract the selected segment from the optical video storage media to a directed location, such as storage medium 40. Moreover, such logic also preferably may disable extraction and/or send a notification where a disc or data is content-protected using a technology such as Content Scrambling System (CSS) encoding. Alternatively or in addition, logic 32 preferably includes functionality that includes decoding for VOB structure present on any optical video storage medium, as the user desires.

FIG. 2 illustrates an example of a method for video extraction according to the present invention. Various embodiments may utilize fewer or more steps, and the method may be performed using a number of different implementations; depending on the application. Generally, embodiments of the method provide for video clips, or video segments, to be identified from at least one video data stream using a variety of methods, whether known or developed in the future. These video segments may be extracted from these at least one video data stream, and then stored onto optical video storage media for subsequent processing as desired, such as indexing. As one example, the VOB format enables a user to view an index or catalog of scenes that are contained on the DVD disc. Thereafter, the extracted video data stored on the DVD disc may be viewed on a conventional DVD movie player or other device.

An embodiment of the method begins in step 202, where digital video data is provided on optical video storage media. As an illustrative scenario, such digital video data may be provided on a first and second DVDs used to archive home movies originally filmed in 8 mm, and a third DVD data compilation captured from data streamed from the Internet. In step 204, a user selects at least one desired video segment from the video data provided from at least one optical data source 20. This step may be performed using a variety of methods, including the identification of the start and end of each segment using logic 32.

In step 206, the method optionally queries whether the video data and/or the optical video storage medium is content-protected. In a particular embodiment, the method may detect whether CSS encoding has been enabled to protect copyrighted or copyrightable material. If so, the method ends, thus providing a measure of digital rights management. Alternatively or in addition, the method may notify the user of the attempt to copy the data in violation of the content protection mechanism.

If, on the other hand, video data and/or the optical video storage medium is not content-protected, the method proceeds to optional step 208, where the method queries whether the video data stream is formatted using VOB format, which is a current standard for DVD movies. If so, the method proceeds to step 210 to decode the VOB file(s) in the selected segment by one of a variety of known methods before proceeding to step 212. For example, the decoding may be performed by determining a structure of each VOB file so that the video data stream may be extracted and then manipulated as any other video clip. Usually the video data stream is encoded using Moving Pictures Expert Group (MPEG). If, on the other hand, the video data stream is not formatted using VOB, the method proceeds directly to step 212.

In step 212, the method extracts the desired video segment from the video data by using one of a variety of methods. For example, a user may invoke selected functionality of an authoring software engine such as MYDVD that will perform the extraction. The method then proceeds to step 214, where the extracted video data is processed. For example, the extracted data may be automatically or manually identified or marked. The identified extracted data may be subsequently indexed, converted, and formatted using a variety of methods now known or hereinafter developed, including manual methods. In a particular embodiment, this step may include encoding or formatting the indexed video data into a particular format or data structure that may be used to store the video data on a medium associated with optical storage system 40. For example, video data may be formatted or encoded in VOB or UDF format for convenient storage on an optical video storage medium associated with media storage system 40. Encoding and formatting are changes well-known in the art and easily provided for by persons having ordinary skill in the art after having becoming familiar with the teachings in the present invention.

The present invention contemplates performing steps during embodiments of the method in various order, and thus the present invention should not be regarded as limited to processes or inserted steps that are performed in any particular order. For example, steps 206 and 208 performed in different order on many types of data and, thus may be placed at any convenient position in the method. Still other configurations are possible, depending on the types of data existing at any particular stage during the method, and on the particular implementation of system 10.

FIG. 3 graphically illustrates a representation of an example of a video segment that may be extracted from an optical video storage medium according to the present invention. Embodiments of the present invention may provide video extraction from optical video storage media such as DVDs without requiring a user to copy the storage capacity of the storage media to a computer's hard drive. As illustrated in FIG. 3, recordable capacity 300 graphically shows a two-dimensional representation of a media structure to illustrate the concept of data being written in rows from side A to side B, such as row 330. The illustrated example is used for illustrative, and not limiting, purposes to discuss the processes of selecting and then extracting a video data stream segment 310 from recordable capacity 300.

FIG. 3 illustrates a two-dimensional representation of an optical video storage medium 300 with recordable media structure 340 and a nonrecordable media area 350. Media structure 340 includes a recorded area 305, which represents data that has been written to the optical video storage medium, beginning with a recorded start point 301 and recorded endpoint 302. For illustration and not limiting purposes, a data stream may be written and/or extracted in rows from side A to side B, such as row 303. FIG. 3 illustrates a selected section 310 that may be extracted using a method similar to the one discussed in conjunction with FIG. 2. Section 310 may be used to represent a video data stream provided from optical video storage media such as DVDs. As illustrated, selected section 310 begins with selected start point 320 and ends with selected end point 330, partially spanning two rows 306 and 307.

Although FIG. 3 graphically illustrates a two-dimensional representation of a media structure 340 on an optical video storage medium 300, the invention contemplates the use of methods known in the art or that may be developed in the future in which video data may be stored on optical video storage media such as DVDs. For example, generally DVDs may be formatted using a recordable capacity 300 operable to store data content such as, but not limited to, video, music, multimedia and other data. In a particular embodiment, recordable capacity 300 may include a Data Zone as provided for in “DVD+RW 4.7 Gbytes Basic Format Specifications,” V1.0, System Description, March 2001 (the “DVD+RW Spec”) Optical video storage media may be formatted using a variety of methods. Moreover, this data may be modified, and/or written in and/or extracted from noncontiguous areas, and processed using a number of methods, including encryption and compression.

What is claimed is:

1. A video segment extraction method, comprising:
selecting a segment from video data encoded on an optical video storage medium; and
copying the segment from the optical video storage medium to another storage medium to be processed.

2. The method of claim 1, further comprising decoding the video data.

3. The method of claim 1, further comprising receiving the video data from one of the group consisting of a video camera, video recorder, and a digital data stream.

4. The method of claim 1, further comprising selecting a segment by marking a selected start point and a selected end point.

5. The method of claim 1, further comprising encoding the video data onto one of the group consisting of a digital versatile disc (DVD), compact disc (CD), and Video Compact Disc (VCD).

6. The method of claim 1, further comprising verifying whether one of the optical video storage medium and at least a portion of the video data is content-protected.

7. The method of claim 1, further comprising sending an error notification if the one of the optical video storage medium and at least a portion of the video data is content-protected.

8. A video segment extraction system, comprising:
a video data processing module; and
video extraction logic operatively associated with the video data processing module and operable to:
cause a segment from video data encoded on an optical video storage medium to be selected; and
cause the segment from the optical video storage medium to be copied to another storage medium to be processed.

9. The system of claim 8, wherein the video extraction logic is further operable to verify whether one of the optical video storage medium and at least a portion of the video data is content-protected.

10. The system of claim 8, wherein the video extraction logic is further operable to send an error notification if one of the optical video storage medium and at least a portion of the video data is content-protected.

11. The system of claim 8, wherein the another storage medium comprises one of the group consisting of a digital versatile disc (DVD), compact disc (CD), and video compact disc (VCD).

12. The system of claim 8, further comprising a video-authoring engine operatively associated with the video data processing module and operable to enable selection of a segment by a marked selected start point and a selected end point.

13. The system of claim 8, wherein the video extraction logic is further operable to decode the data.

14. A video segment extraction application, comprising:
a storage medium; and
video extraction application software communicatively associated with the storage medium and operable to:
cause a segment from video data encoded on an optical video storage medium to be selected; and
cause the segment from the optical video storage medium to be copied to another storage medium to be processed.

15. The system of claim 14, wherein the application software further comprises a video-authoring engine communicatively associated with the storage medium and operable to enable selection of a segment by a marked selected start point and a selected end point.

16. The system of claim 14, wherein the application software is further operable to verify whether one of the optical video storage medium and at least a portion of the video data is content-protected.

17. The system of claim 14, wherein the application software is further operable to send an error notification if one of the optical video storage medium and at least a portion of the video data is content-protected.

18. The system of claim 14, wherein the application software is further operable to decode the data.

19. The system of claim 14, wherein the another storage medium comprises another optical video storage medium.

20. A video segment extraction method, comprising:
selecting a segment from video data encoded on a digital video disc (DVD); and
copying the segment from the DVD to a storage medium.

21. The method of claim 20, further comprising receiving the video data from one of the group consisting of a video camera, video recorder, and a digital data stream.

22. The method of claim 20, further comprising selecting a segment by marking a selected start point and a selected end point.

23. The method of claim 20, further comprising encoding the video data onto the storage medium selected from the group consisting of a digital versatile disc (DVD), compact disc (CD), and Video Compact Disc (VCD).

24. The method of claim 20, further comprising verifying whether one of the DVD and at least a portion of the video data is content-protected.

25. The method of claim 20, further comprising sending an error notification if the one of the DVD and at least a portion of the video data is content-protected.

26. A video segment extraction system, comprising:
a video data processing module; and
video extraction logic operatively associated with the video data processing module and operable to:
cause a segment from video data encoded on a digital video disc (DVD) to be selected; and
cause the segment from the DVD to be copied to a storage medium to be processed.

27. The system of claim 26, wherein the video extraction logic is further operable to verify whether one of the DVD and at least a portion of the video data is content-protected.

28. The system of claim 26, wherein the video extraction logic is further operable to send an error notification if one of the DVD and at least a portion of the video data is content-protected.

29. The system of claim 26, wherein the storage medium comprises one of the group consisting of a digital versatile disc (DVD), compact disc (CD), and video compact disc (VCD).

30. The system of claim 26, further comprising a video-authoring engine operatively associated with the video data processing module and operable to enable selection of a segment by a marked selected start point and a selected end point.

31. The system of claim 26, wherein the video extraction logic is further operable to decode the data from the DVD.

32. A video segment extraction application, comprising:
a storage medium; and
video extraction application software communicatively associated with the storage medium and operable to:
cause a segment from video data encoded on a digital video disc (DVD) to be selected; and
cause the segment from the DVD to be copied to another storage medium for further processing.

33. The system of claim 32, wherein the application software further comprises a video-authoring engine communicatively associated with the storage medium and operable to enable selection of a segment by a marked selected start point and a selected end point.

34. The system of claim 32, wherein the application software is further operable to verify whether one of the DVD and at least a portion of the video data is content-protected.

35. The system of claim 32, wherein the application software is further operable to send an error notification if one of the DVD and at least a portion of the video data is content-protected.

36. The system of claim 32, wherein the application software is further operable to decode the data from the DVD.

37. The system of claim 32, wherein the another storage medium comprises an optical video storage medium.
